(19) United States
(12) Patent Application Publication
(10) Pub. No.: US 2014/0249917 A1
(43) Pub. Date: Sep. 4, 2014

(54) METHOD AND SYSTEM FOR A HOSTED MERCHANT AND CARDHOLDER TRANSACTION CACHE

(71) Applicant: MASTERCARD INTERNATIONAL INCORPORATED, Purchase, NY (US)

(72) Inventor: Peter GROARKE, Dublin (IE)

(73) Assignee: MasterCard International Incorporated, Purchase, NY (US)

(21) Appl. No.: 13/782,385

(22) Filed: Mar. 1, 2013

(51) Int. Cl. G06Q 40/00

(52) U.S. Cl. CPC G06Q 40/10
USPC 705/14.53; 705/30

(57) ABSTRACT

A method for distributing cardholder transaction information includes: storing, in a database, a plurality of transaction data entries, wherein each transaction data entry includes data related to a previously conducted financial transaction involving at least one of a plurality of merchants and includes at least a merchant identifier, a consumer identifier, a transaction time and/or date, and transaction data; receiving, by a receiving device, a transaction cache request, wherein the transaction cache request includes at least a specific merchant identifier; identifying, by a processing device, a transaction data entry subset, wherein the transaction data entry subset includes a subset of the plurality of transaction data entries and where each transaction data entry in the transaction data entry subset includes at least the specific merchant identifier; and transmitting, by a transmitting device, the transaction data entry subset to a merchant associated with the specific merchant identifier.

### FIELD

The present disclosure relates to the hosting of a cache of merchant and cardholder financial transactions, specifically the hosting of a cache of financial transactions available for distribution a merchant.

### BACKGROUND

The development of a stronger relationship between a merchant and consumer can be to the benefit of both parties. The merchant may receive added revenue from the repeat business of the consumer, and the consumer may receive benefits from the merchant from their ongoing relationship. In order to foster this type of relationship, some merchants electronically store a transaction history for transactions conducted between themselves and a consumer. Electronic storage of such a transaction history may benefit the merchant in terms of developing a loyalty program, incentivizing repeat consumers, and resolving disputes, and may be a faster and easier solution to storing a transaction history than traditional use of a handwritten ledger.

However, such systems often require a significant amount of resources, both economically and technologically. In many instances, such systems may be too costly, too difficult to implement, or otherwise require more resources than available for a merchant. Particularly, many small businesses may be unable to afford such a system or have the capacity necessary to run and/or maintain such a system. Merchants who do not utilize such a system may be left at a disadvantage as consumers may prefer to transact with merchants who utilize a system that may be able to more easily provide a loyalty program to the consumer and allow for dispute resolution without the need for receipts and/or records of a transaction. This may result in less revenue to the merchant, which may make the adoption of such a system even more difficult, causing further harm to the merchant's business.

Thus, there is a need for a technical solution to provide a cache of merchant and cardholder financial transactions to a merchant.

### SUMMARY

The present disclosure provides a description of a systems and methods for the distribution of cardholder transaction information to a merchant.

A method for distributing cardholder transaction information includes: storing, in a database, a plurality of transaction data entries, wherein each transaction data entry includes data related to a previously conducted financial transaction involving at least one of a plurality of merchants and includes at least a merchant identifier, a consumer identifier, a transaction time and/or date, and transaction data; receiving, by a receiving device, a transaction cache request, wherein the transaction cache request includes at least a specific merchant identifier; identifying, by a processing device, a transaction data entry subset, wherein the transaction data entry subset includes a subset of the plurality of transaction data entries and where each transaction data entry in the transaction data entry subset includes at least the specific merchant identifier; and transmitting, by a transmitting device, the transaction data entry subset to a merchant associated with the specific merchant identifier.

A system for distributing cardholder transaction information includes a database, a receiving device, a processing device, and a transmitting device. The database is configured to store a plurality of transaction data entries, wherein each transaction data entry includes data related to a previously conducted financial transaction involving at least one of a plurality of merchants and includes at least a merchant identifier, a consumer identifier, a transaction time and/or date, and transaction data. The receiving device is configured to receive a transaction cache request, wherein the transaction cache request includes at least a specific merchant identifier. The processing device is configured to identify a transaction data entry subset, wherein the transaction data entry subset includes a subset of the plurality of transaction data entries and where each transaction data entry in the transaction data entry subset includes at least the specific merchant identifier. The transmitting device is configured to transmit the transaction data entry subset to a merchant associated with the specific merchant identifier.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for the distribution of cardholder transaction information in accordance with exemplary embodiments.

FIG. 2 is a block diagram illustrating an embodiment of a processing server for use in the system of FIG. 1 in accordance with exemplary embodiments.

FIG. 3 is a block diagram illustrating a transaction database of the processing server of FIG. 2 in accordance with exemplary embodiments.

FIG. 4 is a flow chart illustrating a process for storing and distributing consumer transactions from a cache to merchant in accordance with exemplary embodiments.

FIG. 5 is a flow chart illustrating an exemplary method for distributing cardholder transaction information in accordance with exemplary embodiments.

FIG. 6 is a block diagram illustrating computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Definition of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include gift cards, personalized gift cards, payment cards, letters of credit, checks, financial accounts, etc. Examples of networks or systems configured to perform as payment networks include those operated by MasterCard®, VISA®, Discover®, American Express®, etc.

Payment Account—A financial account that may be used to fund a transaction, such as a checking account, savings account, credit account, virtual payment account, etc. A payment account may be associated with an entity, which may include a person, family, company, corporation, governmental entity, etc. In some instances, a payment account may be virtual, such as those accounts operated by PayPal®, etc.

Payment Card—A card or data associated with a payment account that may be provided to a merchant in order to fund a financial transaction via the associated payment account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant, or may be data representing the associated payment account (e.g., as stored in a communication device, such as a smart phone or computer). For example, in some instances, data including a payment account number may be considered a payment card for the processing of a transaction funded by the associated payment account. In some instances, a check may be considered a payment card where applicable.

### System for Distributing and Processing Personalized Gift Cards

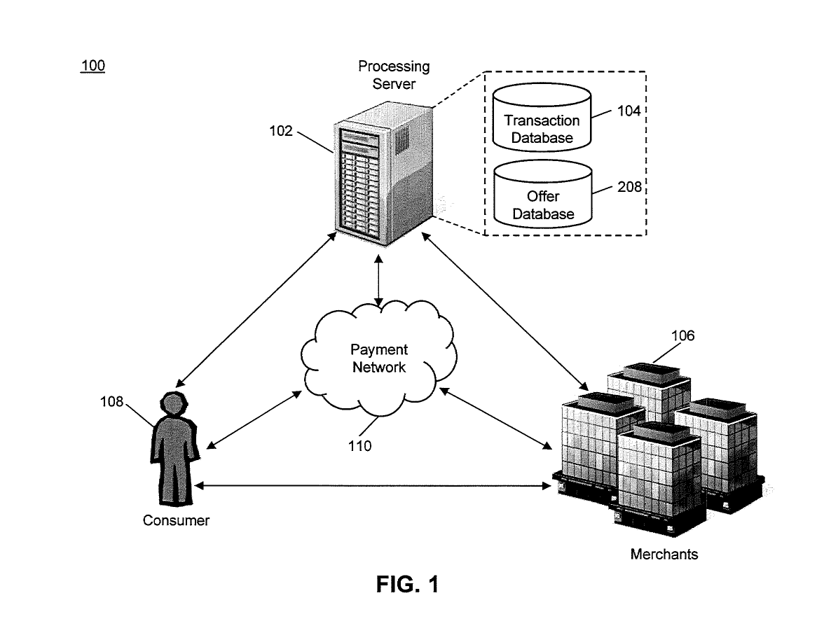

FIG. 1 is a block diagram illustrating a system 100 for storing a merchant-cardholder transaction cache and the distribution of cardholder transaction information to a merchant.

The system 100 may include a processing server 102. The processing server 102, discussed in more detail below, may be configured to store a cache of merchant-cardholder financial transactions. The processing server 102 may include a transaction database 104, discussed in more detail below, for storing data related to a plurality of previously conducted financial transactions. The plurality of previously conducted financial transactions may include financial transactions involving at least one consumer 108 and a plurality of merchants 106. Previously conducted financial transactions may include any previously authorized and/or cleared financial transaction such that it may include cleared financial transactions as well as financial transactions that have been authorized but may have not yet cleared.

The consumer 108 (e.g., a cardholder) may enter into a financial transaction with a merchant 106. The merchant 106 (e.g., or an acquiring bank on behalf of the merchant 106) may submit an authorization request for the financial transaction to a payment network 110 (e.g., MasterCard®, VISA®, American Express®, Discover®, etc.) for processing. The payment network 110 may process the authorization request and return an authorization response to the merchant 106 indicating approval or denial of the financial transaction. The merchant 106 may then finalize the transaction with the consumer 108, such as by providing the transacted for goods and/or services (e.g., products) to the consumer 108 or providing a receipt to the consumer 108. Systems and methods suitable for the processing of a financial transaction will be apparent to persons having skill in the relevant art.

The payment network 110 may, with the consent of the consumer 108, provide data related to the financial transaction between the consumer 108 and the merchant 106 to the processing server 102. The processing server 102 may then store the data in the transaction database 104. In some instances, the processing server 102 may receive transaction data directly from a merchant 106 (e.g., also with the consent of the consumer 108).

A merchant 106 of the plurality of merchants may have a desire to view a transaction history between the consumer 108 and themselves. The merchant 106 may submit a transaction cache request to the processing server 102 (e.g., via a network, such as the Internet). The transaction cache request may identify the merchant 106 and the consumer 108 for which the transaction history is requested. The processing server 102 may identify the requested data in the transaction database, and may return the data to the merchant 106. In some instances, the processing server 102 may remove selected data prior to providing the transaction history to the merchant 106, such as based on preferences of the consumer 108. For example, the consumer 108 may specify that a particular merchant 106 may not receive funding information for any financial transactions, such as information identifying the payment card used in a financial transaction.

The merchant 106 may receive the requested information. The merchant 106 may use the information to provide discounts or offers to the consumer 108, to resolve a transaction dispute with the consumer 108, may process a return or exchange for the consumer 108 (e.g., without the need for the consumer 108 to provide a receipt), etc. In some embodiments, the transaction cache request may further include a transaction time and/or date or a range of transaction times and/or dates for which transaction data is requested. In a further embodiment, the transaction cache request may specify a single transaction, such as by a specific transaction time and date or a unique transaction identifier associated with the financial transaction.

In some instances, the merchant 106 may submit the transaction cache request to the processing server 102 at the point-of-sale, such as prior to, during, or immediately after the processing of a financial transaction. For example, the merchant 106 may request previous transaction data prior to the submitting of an authorization request for a financial transaction, such as for providing an offer to the consumer 108 based on past transactions. In another example, the merchant 106 may identify the consumer 108 when the consumer enters a store and may thereby submit the transaction cache request to the processing server 102 prior to the consumer 108 initiating a financial transaction. In such an instance, the merchant 106 may be able to identify the consumer 108 prior to the transaction to enrich the consumer's 108 experience. For example, the consumer 108 may swipe a loyalty card, for example, or otherwise provide an identifier upon entering a merchant coffee shop, the merchant 106 may submit (e.g., automatically) a transaction cache request to the processing server 102, may receive transaction data for transactions involving the consumer 108 and the merchant coffee shop, and may be able to identify the consumer 108 and their regular order, and may be able to greet the consumer 108 by name and have their regular order ready by the time they reach the counter.

In some embodiments, the processing server 102 may be configured to provide offers (e.g., coupons, discounts, deals, etc.) to the consumer 108 based on transaction history on behalf of the merchant 106. The processing server 102 may include an offer database 208 configured to store data related to a plurality of offers. Each offer may be associated with a merchant 106 and at least one predetermined criteria. When the processing server 102 identifies transaction data as part of the transaction cache request, the processing server 102 may further identify any eligible offers in the offer database 208 where the at least one predetermined criteria is met based on the identified transaction data. The processing server 102 may then distribute the eligible offers to the consumer 108 or to the merchant 106.

In embodiments where the transaction cache request may be received temporally proximal to a financial transaction, the processing server 102 may distribute an eligible offer to the payment network 110. The payment network 110 may then modify an authorization request for the financial transaction based on the eligible offer, and may process the modified authorization request. In such an embodiment, the consumer 108 may have an offer identified and automatically applied to a financial transaction based on their transaction history with the merchant 106 without any user action required. In some instances, the consumer 108 may provide preferences as to the automatic redemption of an offer based on transaction history with a merchant 106.

In some instances, the system 100 may be beneficial for dispute resolution between the consumer 108 and the merchant 106. For example, the consumer 108 may view their account statement for a payment card and may see a transaction that the consumer 108 does not recall conducting. In traditional systems, the consumer 108 could initiate a chargeback to the payment card processor, which requires the processor to contact the merchant 106 and/or the issuer of the payment card. In cases where the merchant 106 may be a small business without the resources to store transaction data, such a process may take significant time and resources for all parties involved. In the system 100, the consumer 108 and/or the merchant 106 may request their shared transaction history, may identify the transaction, and directly communicate to resolve the dispute. If a chargeback is determined to be necessary, then the payment card processor may process the chargeback with the merchant 106 already onboard having previously reviewed the transaction. In such an instance, the disputed transaction may be resolved in less time and utilizing fewer resources using the system 100.

In addition, the system 100 may also result in improved processing of chargebacks. For example, if the consumer 108 initiates a chargeback, the payment card processor may communicate with the processing server 102. The processing server 102 may provide detailed information regarding the transaction as stored in the transaction database 104 to the merchant 106. The merchant 106 may then, having more detailed information at their disposal, more quickly identify information necessary to resolve the chargeback. In such an instance, a chargeback may be processed more quickly and the merchant 106 may have more information available in order to assist with the chargeback process than in traditional systems.

### Processing Server

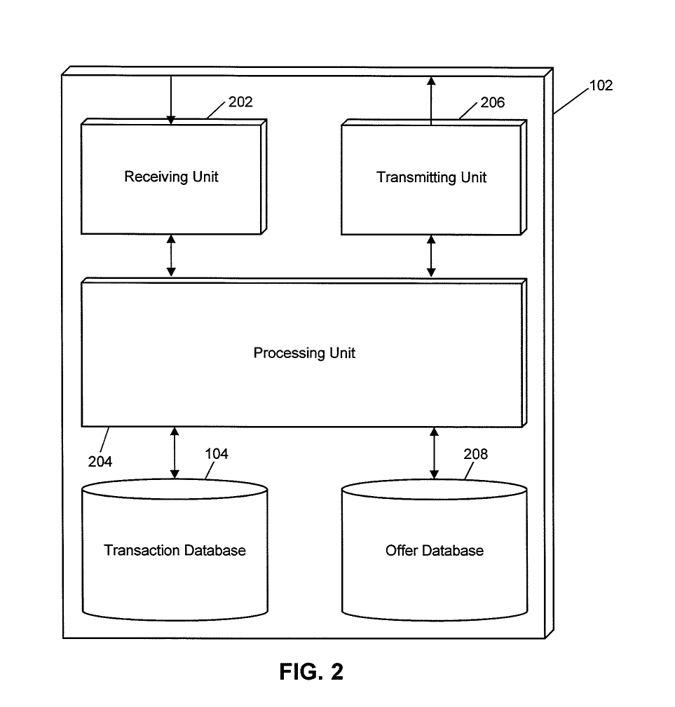

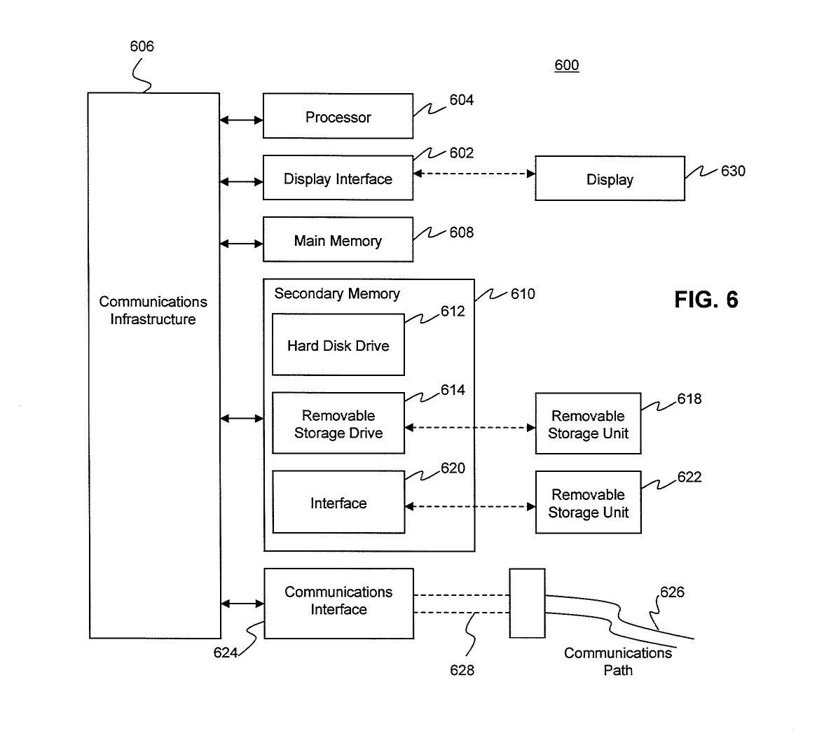

FIG. 2 illustrates an embodiment of the processing server 102 of the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 600 illustrated in FIG. 6 and discussed in more detail below may be a suitable configuration of the processing server 106.

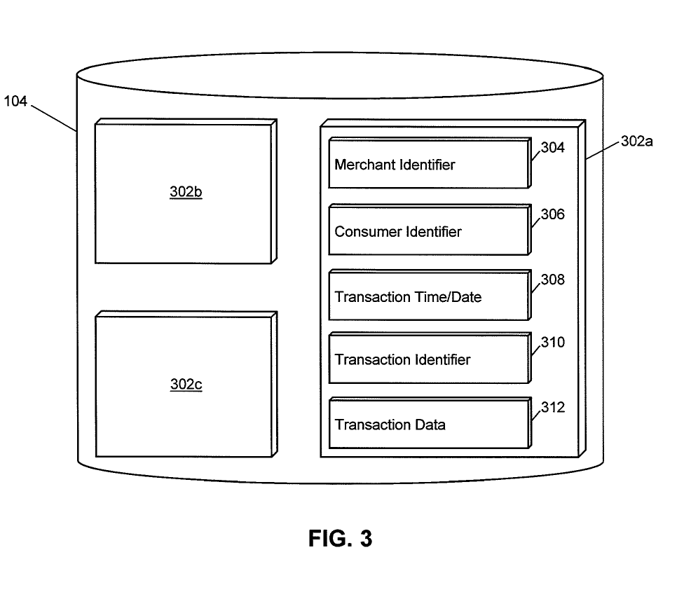

The processing server 102 may include a receiving unit 202. The receiving unit 202 may be configured to receive data related to previously conducted financial transactions. The processing server 102 may also include a processing unit 204, which may be configured to enter transaction data entries into the transaction database 104 for the received data corresponding to each of the previously conducted financial transactions. The data stored in the transaction database 104 is discussed in more detail below with respect to FIG. 3.

The receiving unit 202 may be further configured to receive a transaction cache request. The transaction cache request may include at least a merchant identifier, but may further include a consumer identifier, a time and/or date period, or a transaction identifier. The processing unit 204 may, based on the transaction cache request, identify a subset of transaction data entries in the transaction database 104. For example, the processing unit 204 may identify a subset of transaction data entries including all previously conducted financial transactions involving the merchant 106 corresponding to the merchant identifier included in the transaction cache request, or may identify those transactions involving both the merchant 106 and the consumer 108, or may further identify transactions after a specific date between the merchant 106 and the consumer 108.

The processing server 102 may also include a transmitting unit 206. The transmitting unit 206 may be configured to transmit the identified transaction data entry subset (e.g., in response to the transaction cache request). The transmitting unit 206 may transmit the identified data in any suitable form as will be apparent to persons having skill in the relevant art. In some instances, the transaction cache request or predetermined merchant preferences may specify the data to be included in the transmitted data. For example, the merchant 106 may request only transaction amounts and transaction dates as relevant to a specific application.

In one embodiment, the receiving unit 202 may be further configured to receive data related to a financial transaction from the merchant 106 or an entity on behalf of the merchant 106. In such an embodiment, the processing unit 204 may be configured to store a transaction data entry in the transaction database 104 corresponding to the received financial transaction data, as discussed in more detail below. This may enable the processing server 102 to store data related to financial transactions that may not be processed by a payment network 110, such as for cash transactions. By storing transaction data for cash transactions in the transaction database 104, the processing server 102 may be able to assist the merchant 106 with offer identification and distribution, refund and exchange processing, and dispute resolution, without restriction as to the method of payment.

In some embodiments, the processing server 102 may also include the offer database 208. The offer database 208 may be configured to store a plurality of offer data entries, wherein each offer data entry includes data related to an offer and includes at least an offer identifier and at least one predetermined criteria. The offer identifier may be a value unique to the corresponding offer used for identification of the offer data entry, such as a Universal Product Code (UPC), stock-keeping unit (SKU), serial number, etc. The processing unit 204 may be configured to identify, in the offer database 208, at least one offer data entry corresponding to an eligible offer based on the identified subset of transaction data entries where the at least one predetermined criteria for each identified offer data entry is met based on the subset of transaction data entries. The transmitting unit 206 may be configured to transmit each eligible offer related to the identified offer data entries, such as to the consumer 108, the merchant 106, or the payment network 110.

### Transaction Database

FIG. 3 is an illustration of the transaction database 104 of the processing server 102. The transaction database 104 is configured to store a plurality of transaction data entries 302, illustrated in FIG. 3 as transaction data entries 302a, 302b, and 302c. Each transaction data entry may include data related to a previously conducted financial transactions and may include a merchant identifier 304, a consumer identifier 306, a transaction time and/or date 308, and transaction data 312. In some embodiments, a transaction data entry 302 may further include a transaction identifier 310.

The merchant identifier 304 may be a value corresponding to a merchant (e.g., the merchant 106) used for identification of the corresponding merchant involved in the financial transaction to which the transaction data entry 302 is related. In some instances, the merchant identifier 304 may be unique to the corresponding merchant, such as a Merchant Identification Number (MID). Values suitable for use as the merchant identifier 304 will be apparent to persons having skill in the relevant art. In one embodiment, merchant identifiers may be associated with merchants by the processing server 102 or an entity associated with the processing server 102.

The consumer identifier 306 may be a value corresponding to a consumer (e.g., the consumer 102) used for identification of the corresponding consumer involved in the financial transaction to which the transaction data entry 302 is related. The consumer identifier 306 may be unique to a consumer such that the consumer identifier 306 may be associated with only a single consumer 108. In some embodiments, each consumer 108 may be associated with multiple consumer identifiers 306. For example, the consumer identifier 306 may be a payment card number or a payment account number. In such an example, a consumer 108 may be associated with multiple payment card or payment account numbers. In some embodiments, the consumer identifier 306 may be a loyalty number or other value identified by the merchant 106.

The transaction time and/or date 308 may be the time and/or date when the corresponding financial transaction took place. In some embodiments, it may be based on the submission of the authorization request. In other embodiments, the transaction time and/or date 308 may be based on information obtained from the merchant 106. For example, the merchant 106 may conduct the financial transaction at the transaction time and/or date 308, but not submit an authorization request until a later time and/or date. In some instances, a financial transaction may be submitted to the processing server 102 for storage in the transaction database 104 without the use of an authorization request, such as the submission of a cash transaction.

The transaction data 312 may be any data related to the corresponding financial transaction that may be suitable for use by the merchant 106 and/or the processing server 102 as will be apparent to persons having skill in the relevant art. The transaction data 312 may include, for example, at least one of: a transaction amount, payment method, payment card number, check number, product name, product price, product quantity, loyalty number, shipping method, shipping details, product details, point-of-sale, clerk name, clerk identification number, etc.

The transaction identifier 310 may be a value used for identification of the related financial transaction and/or the transaction data entry 302. The transaction identifier 310 may be a serial number or other type of value suitable for the identification of financial transactions as will be apparent to persons having skill in the relevant art. The transaction identifier 310 may be beneficial in enabling the merchant 106 to identify a specific transaction data entry 302 faster than receiving an entire subset of transaction data entries 302, such as for use in processing a refund or exchange or for addressing a dispute. In such an embodiment, the transaction cache request may include at least the transaction identifier 310 and the merchant identifier 304 for identification of the single transaction data entry 302 related to the requested financial transaction.

### Method for Identifying and Distributing Cardholder Transactions

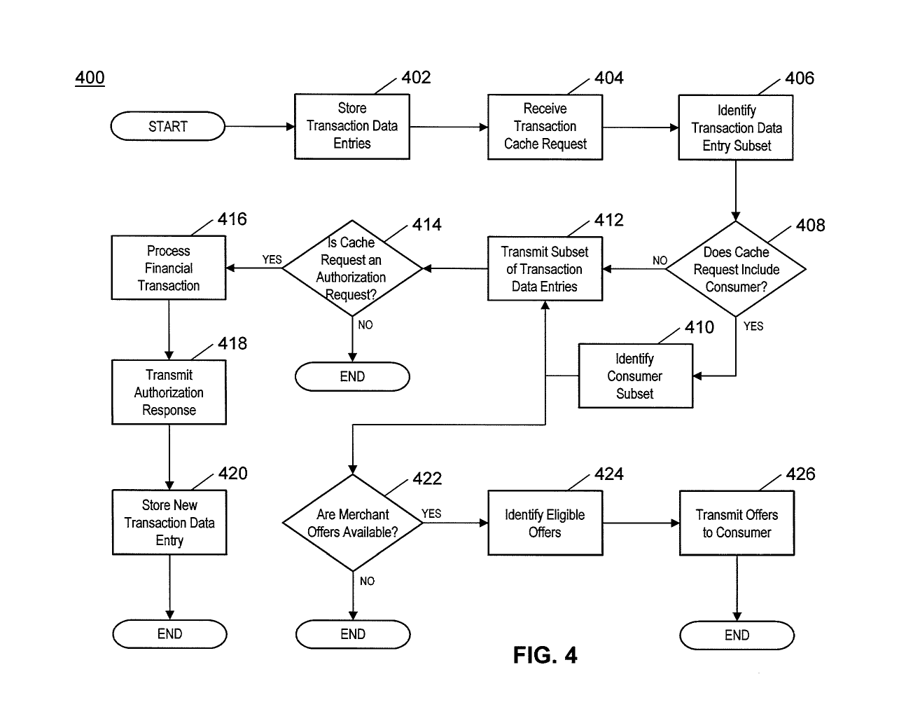

FIG. 4 illustrates a processing flow for the processing server 102 for the identification of the subset of transaction data entries 302 and the distribution of request transaction data entries 302 to the merchant 106.

In step 402, the processing server 102 may store transaction data entries 302 in the transaction database 104. The transaction data entries 302 may be related to financial transactions involving at least one consumer 108 and a plurality of merchants 106. In step 404, the receiving unit 202 may receive a transaction cache request, wherein the transaction cache request includes at least a merchant identifier 304.

In step 406, the processing unit 204 of the processing server 102 may identify, in the transaction database 104, a subset of transaction data entries where the merchant identifier 304 for each transaction data entry 302 in the subset of transaction data entries is the merchant identifier 304 included in the transaction cache request. In step 408, the processing unit 204 may identify if the transaction cache request further includes a consumer identifier 306. If the transaction cache request does include a consumer identifier 306, then, in step 410, the processing unit 204 may further narrow the subset of transaction data entries to only include those transaction data entries 302 where the consumer identifier 306 is the consumer identifier 306 included in the transaction cache request.

In step 412, the transmitting unit 206 may transmit the identified subset of transaction data entries in response to the transaction cache request, such as to the merchant 106 corresponding to the merchant identifier 304. In some embodiments, the method may continue to step 414, where the processing unit 204 determines if the transaction cache request is included in or accompanies an authorization request for a financial transaction. If there is no authorization request, then the process 400 may be completed.

If there is an authorization request, then, in step 416, the processing server 102, for example, or the payment network 110 on behalf of the processing server 102, may process the corresponding financial transaction. Methods for processing a financial transaction will be apparent to persons having skill in the relevant art. In step 418, an authorization response based on the transaction processing may be transmitted in response to the authorization request (e.g., to the merchant 106). In step 420, the processing unit 204 may store a new transaction data entry 302 related to the processed financial transaction in the transaction database 104. It will be apparent to persons having skill in the relevant art that, in instances where the transaction is processed by an entity other than the processing server 102, step 420 may include receiving (e.g., by the receiving unit 202) the transaction data for the financial transaction.

In instances where the processing server 102 may include the offer database 208 for the distribution of offers to the consumer 108, after the subset of transaction data entries involving both the merchant 106 and consumer 108 is identified, then, in step 422, the processing unit 204 may identify if any merchant offers are available. For example, the processing unit 204 may identify, in the offer database 208, if there are any offers available for redemption at the merchant 106. If there are no offers available, then the process 400 may end.

If there are offers available, then, in step 424, the processing unit 204 may identify any eligible offers. An offer may be eligible if at least one predetermined criteria included in the offer is met based on the identified subset of transaction data entries. In some embodiments, the predetermined criteria may include a transaction amount for a single or multiple transactions, a transaction frequency, a payment method, a product identifier, a product quantity, etc. For example, an offer may have a predetermined criteria of five transactions in a two week period. If the processing unit 204 identifies that the consumer 108 has previously conducted four transactions with the merchant 106 in the previous two weeks, then the offer may be identified as eligible for redemption.

In step 426, the eligible offers may be transmitted to the consumer 108 and/or to the merchant 106. In some embodiments, an eligible offer may be automatically redeemed. In a further embodiment, automatic redemption of an offer may be based on a consumer preference.

It will be apparent to persons having skill in the relevant art that the process 400 illustrated in FIG. 4 for may be useful in additional applications in addition to the distribution of offers. In some instances, transactions may be identified for the use in processing refunds or exchanges. For example, the processing server 102 may identify a transaction data entry 302 stored in the transaction database 104 corresponding to a specific financial transaction involving the merchant 106 and the consumer 108. The merchant 106 may, using the data included in the transaction data entry 302, identify that the consumer 108 is to receive a refund. The merchant 106 may then notify the processing server 102 (e.g., as part of the payment network 110), which may then process the refund for the financial transaction based on the transaction data 312 stored in the transaction data entry 302.

### Method for Distributing Cardholder Transaction Information

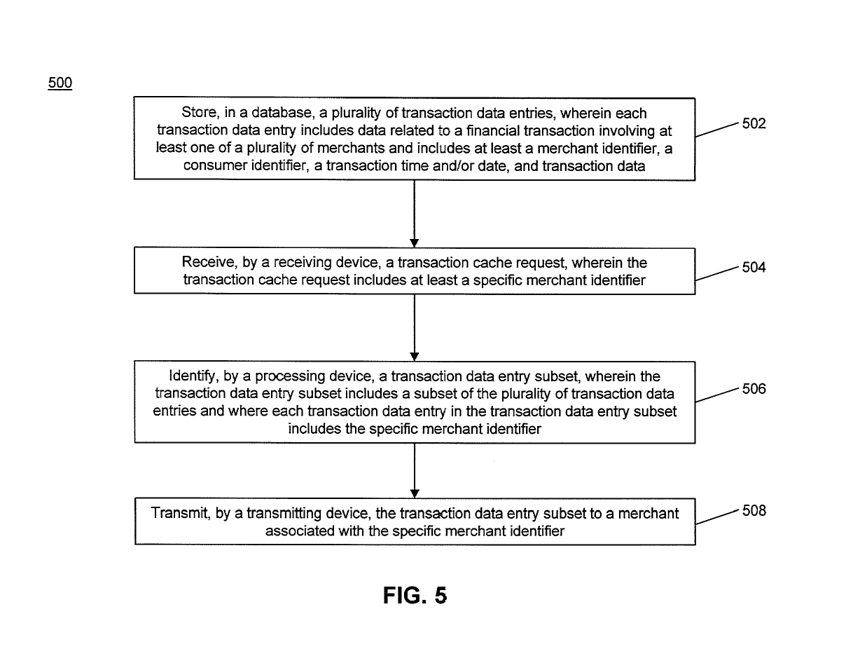

FIG. 5 illustrates a method 500 for the distribution of cardholder transaction information.

In step 502, a plurality of transaction data entries may be stored in a database (e.g., the transaction database 104), wherein each transaction data entry (e.g., the transaction data entry 302) includes data related to a financial transaction involving at least one of a plurality of merchants and includes at least a merchant identifier (e.g., the merchant identifier 304), a consumer identifier (e.g., the consumer identifier 306), a transaction time and/or date (e.g., the transaction time and/or date 308), and transaction data (e.g., the transaction data 312). In some embodiments, the transaction data 312 may include at least one of: a transaction amount, payment method, payment card number, product name, product price, product quantity, and loyalty number. In one embodiment, each transaction data entry 302 may further include a transaction identifier (e.g., the transaction identifier 310).

In step 504, a transaction cache request may be received, by a receiving device (e.g., the receiving unit 202), wherein the transaction cache request includes at least a specific merchant identifier 304. In one embodiment, the transaction cache request may be conveyed with or generated responsive to an authorization request for a financial transaction. In another embodiment, the transaction cache request may be conveyed with or generated responsive to a request for a refund.

In step 506, a transaction data entry subset may be identified, by a processing device (e.g., the processing unit 204), wherein the transaction data entry subset includes a subset of the plurality of transaction data entries and wherein each transaction data entry 302 in the transaction data entry subset includes the specific merchant identifier 304. In embodiments where each transaction data entry 302 may further include a transaction identifier 310, the transaction cache request may further include a specific transaction identifier, and the transaction data entry subset may be a single transaction data entry including the specific transaction identifier.

In one embodiment, the transaction cache request may further include a specified date, and the transaction time and/or date 308 included in each transaction data entry 302 in the transaction data entry subset may be equal to or later than the specified date. In another embodiment, the transaction cache request may further include a specified period of time, and the transaction time and/or date 308 included in each transaction data entry 302 in the transaction data entry subset may be within the specified period of time. In step 508, the transaction data entry subset may be transmitted, by a transmitting device (e.g., the transmitting unit 206) to a merchant (e.g., the merchant 106) associated with the specific merchant identifier 304.

In some embodiments, the transaction cache request may further include a specific consumer identifier, and each transaction data entry 302 in the transaction data entry subset may further include the specific consumer identifier. In a further embodiment, the method 500 may further include: storing, in an offer database (e.g., the offer database 208), a plurality of offer data entries, wherein each offer data entry includes data related to an offer and includes at least an offer identifier and at least one predetermined criteria; identifying, by the processing device 204, at least one offer data entry in the plurality of offer data entries where the included at least one predetermined criteria is met based on the transaction data entry subset; and transmitting, by the transmitting device 206, the offer related to each offer data entry of the identified at least one offer data entry.

In one embodiment, the method 500 may further include receiving, by the receiving device 202, a refund request, wherein the refund request includes at least an account identifier and information identifying a specific transaction data entry 302. The method 500 may then further include processing, by the processing device 204, a refund to an account associated with the account identifier based on at least the transaction data 312 included in the specific transaction data entry 302.

In another embodiment, the method 500 may further include receiving, by the receiving device 202, an authorization request for a financial transaction, wherein the authorization request includes at least an authorization merchant identifier, an authorization consumer identifier, and authorization transaction data. The method 500 may then further include storing, in the database 104, a new transaction data entry 302 including the authorization merchant identifier, authorization consumer identifier, and authorization transaction data. In a further embodiment, the processing device 204 may process the financial transaction and the transmitting device 206 may transmit an authorization response to a merchant 106 associated with the authorization merchant identifier.

### Computer System Architecture

FIG. 6 illustrates a computer system 600 in which embodiments of the present disclosure, or portions thereof, may be implemented as computer-readable code. For example, the merchants 106, the payment network 110, and the processing server 102 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 4 and 5.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device. The processor device 604 may be connected to a communication infrastructure 606, such as a bus, message queue, network (e.g., the payment network 110), multi-core message-passing scheme, etc. The network 110 may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive, the removable storage unit 618 may be a floppy disk. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

Computer program medium and computer usable medium may refer to memories, such as the main memory 608 and secondary memory 610, which may be memory semiconductors (e.g. DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 4 and 5, as discussed herein. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

Techniques consistent with the present disclosure provide, among other features, systems and methods for the distribution of cardholder transaction information. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for distributing cardholder transaction information, comprising:
storing, in a database, a plurality of transaction data entries, wherein each transaction data entry includes data related to a previously conducted financial transaction involving at least one of a plurality of merchants and includes at least a merchant identifier, a consumer identifier, a transaction time and/or date, and transaction data;
receiving, by a receiving device, a transaction cache request, wherein the transaction cache request includes at least a specific merchant identifier;
identifying, by a processing device, a transaction data entry subset, wherein the transaction data entry subset includes a subset of the plurality of transaction data entries and where each transaction data entry in the transaction data entry subset includes at least the specific merchant identifier; and
transmitting, by a transmitting device, the transaction data entry subset to a merchant 106 associated with the specific merchant identifier.

2. The method of claim 1, wherein
the transaction cache request further includes a specific consumer identifier, and
each transaction data entry in the transaction data entry subset further includes the specific consumer identifier.

3. The method of claim 2, further comprising:
storing, in an offer database, a plurality of offer data entries, wherein each offer data entry includes data related to an offer and includes at least an offer identifier and at least one predetermined criteria;
identifying, by the processing device, at least one offer data entry in the plurality of offer data entries where the included at least one predetermined criteria is met based on the transaction data entry subset; and
transmitting, by the transmitting device, the offer related to each offer data entry of the identified at least one offer data entry.

4. The method of claim 1, wherein the transaction cache request is conveyed with or generated responsive to an authorization request for a financial transaction.

5. The method of claim 1, wherein the transaction cache request is conveyed with or generated responsive to a request for a refund.

6. The method of claim 1, wherein the transaction data includes at least one of: a transaction amount, payment method, payment card number, product name, product price, product quantity, and loyalty number.

7. The method of claim 1, wherein each transaction data entry of the plurality of transaction data entries further includes a transaction identifier.

8. The method of claim 7, wherein the transaction cache request further includes a specific transaction identifier and the transaction data entry subset is a single transaction data entry including the specific transaction identifier.

9. The method of claim 1, further comprising:
receiving, by the receiving device, a refund request, wherein the refund request includes at least an account identifier and information identifying a specific transaction data entry; and
processing, by the processing device, a refund to an account associated with the account identifier based on at least the transaction data included in the specific transaction data entry.

10. The method of claim 1, further comprising:
receiving, by the receiving device, an authorization request for a financial transaction, wherein the authorization request includes at least an authorization merchant identifier, an authorization consumer identifier, and authorization transaction data; and
storing, in the database, a new transaction data entry including the authorization merchant identifier, authorization consumer identifier, and authorization transaction data.

11. The method of claim 10, further comprising:
processing, by the processing device, the financial transaction; and
transmitting, by the transmitting device, an authorization response to a merchant 106 associated with the authorization merchant identifier.

12. The method of claim 1, wherein
the transaction cache request further includes a specified date, and
the transaction time and/or date included in each transaction data entry in the transaction data entry subset is equal to or later than the specified date.

13. The method of claim 1, wherein
the transaction cache request further includes a specified period of time, and
the transaction time and/or date included in each transaction data entry in the transaction data entry subset is within the specified period of time.

14. A system for distributing cardholder transactions, comprising:
a database configured to store a plurality of transaction data entries, wherein each transaction data entry includes data related to a previously conducted financial transaction involving at least one of a plurality of merchants and includes at least a merchant identifier, a consumer identifier, a transaction time and/or date, and transaction data;
a receiving device configured to receive a transaction cache request, wherein the transaction cache request includes at least a specific merchant identifier;
a processing device configured to identify a transaction data entry subset, wherein the transaction data entry subset includes a subset of the plurality of transaction data entries and where each transaction data entry in the transaction data entry subset includes at least the specific merchant identifier; and
a transmitting device configured to transmit the transaction data entry subset to a merchant associated with the specific merchant identifier.

15. The system of claim 14, wherein
the transaction cache request further includes a specific consumer identifier, and
each transaction data entry in the transaction data entry subset further includes the specific consumer identifier.

16. The system of claim 15, further comprising:
an offer database configured to store a plurality of offer data entries, wherein each offer data entry includes data related to an offer and includes at least an offer identifier and at least one predetermined criteria, wherein
the processing device is further configured to identify at least one offer data entry in the plurality of offer data entries where the included at least one predetermined criteria is met based on the transaction data entry subset, and
the transmitting device is further configured to transmit the offer related to each offer data entry of the identified at least one offer data entry.

17. The system of claim 14, wherein the transaction cache request is conveyed with or generated responsive to an authorization request for a financial transaction.

18. The system of claim 14, wherein the transaction cache request is conveyed with or generated responsive to a refund request.

19. The system of claim 14, wherein the transaction data includes at least one of: a transaction amount, payment method, payment card number, product name, product price, product quantity, and loyalty number.

20. The system of claim 14, wherein each transaction data entry of the plurality of transaction data entries further includes a transaction identifier.

21. The system of claim 20, wherein the transaction cache request further includes a specific transaction identifier and the transaction data entry subset is a single transaction data entry including the specific transaction identifier.

22. The system of claim 14, wherein
the receiving device is further configured to receive a refund request, wherein the refund request includes at least an account identifier and information identifying a specific transaction data entry; and
the processing device is further configured to process a refund to an account associated with the account identifier based on at least the transaction data included in the specific transaction data entry.

23. The system of claim 14, wherein
the receiving device is further configured to receive an authorization request for a financial transaction, wherein the authorization request includes at least an authorization merchant identifier, an authorization consumer identifier, and authorization transaction data, and
the processing device is further configured to store, in the database, a new transaction data entry including the authorization merchant identifier, authorization consumer identifier, and authorization transaction data.

24. The system of claim 23, wherein
the processing device is further configured to process the financial transaction; and
the transmitting device is further configured to transmit an authorization response to a merchant associated with the authorization merchant identifier.

25. The system of claim 14, wherein
the transaction cache request further includes a specified date, and
the transaction time and/or date included in each transaction data entry in the transaction data entry subset is equal to or later than the specified date.

26. The system of claim 14, wherein
the transaction cache request further includes a specified period of time, and
the transaction time and/or date included in each transaction data entry in the transaction data entry subset is within the specified period of time.

27. A non-transitory computer-readable recording medium having program code stored therein that causes a processor of a computing device to execute the following steps:
storing, in a database, a plurality of transaction data entries, wherein each transaction data entry includes data related to a previously conducted financial transaction involving at least one of a plurality of merchants and includes at least a merchant identifier, a consumer identifier, a transaction time and/or date, and transaction data;
receiving, by a receiving device, a transaction cache request, wherein the transaction cache request includes at least a specific merchant identifier;
identifying, by a processing device, a transaction data entry subset, wherein the transaction data entry subset includes a subset of the plurality of transaction data entries and where each transaction data entry in the transaction data entry subset includes at least the specific merchant identifier; and
transmitting, by a transmitting device, the transaction data entry subset to a merchant 106 associated with the specific merchant identifier.
